(19) United States
(12) Patent Application Publication
(10) Pub. No.: US 2025/0096407 A1
(43) Pub. Date: Mar. 20, 2025

(54) Battery Pack And Vehicle Including Same

(71) Applicant: LG Energy Solution, Ltd., Seoul (KR)

(72) Inventors: Yong-Ho Lee, Daejeon (KR); So-Jeong Park, Daejeon (KR); Jong-Min Song, Daejeon (KR); Jun-Young Ahn, Daejeon (KR); Kwang-Keun Oh, Daejeon (KR); In-Hyuk Jung, Daejeon (KR); Jin-Oh Yang, Daejeon (KR)

(73) Assignee: LG Energy Solution, Ltd., Seoul (KR)

(21) Appl. No.: 18/828,602

(22) Filed: Sep. 9, 2024

(30) Foreign Application Priority Data
Sep. 15, 2023 (KR) 10-2023-0123393

(51) Int. Cl. H01M 50/383; H01M 10/613; H01M 10/625; H01M 10/643; H01M 10/6551; H01M 50/213; H01M 50/358

(52) U.S. Cl. CPC H01M 50/383; H01M 10/613; H01M 10/625; H01M 10/643; H01M 10/6551; H01M 50/213; H01M 50/358

(57) ABSTRACT

Disclosed herein is a battery pack. The battery pack can include a plurality of battery cells, a pack case defining a housing configured to accommodate the battery cells, a first venting path extending across the pack case, and a second venting path extending along at least one peripheral side of the pack case. The first venting path can provide a conduit for a gas generated from any of the battery cells. The second venting path can be in fluid communication with the first venting path and an opening on the pack case such that the gas from the battery cells is configured to travel from the first venting path to the second venting path and to be discharged from the battery pack via the opening.

### CROSS-REFERENCE TO RELATED APPLICATIONS

The present application claims priority to Korean Patent Application No. 10-2023-0123393 filed on Sep. 15, 2023, the disclosure of which is incorporated by reference in its entirety.

### TECHNICAL FIELD

The present disclosure relates to a battery pack, and more specifically, it relates to a battery pack configured to quickly discharge venting gas generated from a trigger cell to the outside of the pack case, and rapidly and efficiently dissipate heat to the pack case by conduction, thereby suppressing the risk of ignition in the battery pack, and a vehicle including the same.

### BACKGROUND OF THE INVENTION

Recently, the demand for portable electronic products such as laptops, video cameras, and portable phones has rapidly increased, and the development of electric vehicles, energy storage batteries, robots, satellites, and the like has been accelerated, so in line with this, active research on high-performance secondary batteries capable of being repeatedly charged and discharged is underway.

Currently commercialized secondary batteries include nickel cadmium batteries, nickel hydrogen batteries, nickel zinc batteries, and lithium secondary batteries. Among these, lithium secondary batteries are in the spotlight for their advantages of free charging and discharging, a very low self-discharge rate, and high energy density as they have almost no memory effect, compared to nickel-based secondary batteries.

These lithium secondary batteries generally use lithium-based oxides and carbon materials as positive and negative electrode active materials, respectively. In addition, the lithium secondary batteries include positive and negative electrode plates coated with the positive and negative electrode active materials, respectively, an electrode assembly in which the positive and negative electrode plates are disposed with a separator therebetween, and an exterior case that seals and stores the electrode assembly with an electrolyte.

Meanwhile, lithium secondary batteries may be classified, depending on the shape of a battery case, into pouch-type secondary batteries in which the electrode assembly is accommodated in a pouch of an aluminum laminate sheet and can-type secondary batteries in which the electrode assembly is accommodated in a metal can. In addition, can-type secondary batteries may be further classified into cylindrical batteries and prismatic batteries depending on the shape of the metal can. To deliver high voltage and high current, lithium-ion secondary batteries are utilized in the form of battery modules or battery packs. These are created by stacking or arranging multiple battery cells, either directly or within cartridges or similar housings, to form a compact structure, which is then electrically interconnected.

Recently, research and development has been active on battery packs configured to include a single module or cell assembly with improved structural rigidity by densely disposing a plurality of cylindrical battery cells in the standing state and a pack frame surrounding the same. In particular there is a trend towards increasing the surface area of individual modules or cell assemblies.

However, if a thermal event such as thermal runaway occurs in any one battery cell inside the large-area cell assembly, combustible gas triggered in the trigger cell is ejected, and the ignited trigger cell itself becomes a heating electrode and they become ignition sources, causing heat accumulation, which may lead to cascading heat transfer to adjacent battery cells and explosion of the entire battery pack.

Therefore, it is necessary to suppress the risk of ignition and delay or block heat transfer in the battery pack through a venting structure capable of quickly discharging venting gas released from the trigger cell to the outside of the pack case and a heat dissipation structure capable of quickly and efficiently conducting high-temperature heat or the like generated from the trigger cell to the outside before it accumulates.

### BRIEF SUMMARY OF THE INVENTION

The present disclosure has been designed to solve the problems of the related art, and therefore the present disclosure is directed to providing a battery pack in which venting gas generated from the trigger cell may be quickly discharged to the outside of the pack case through a second venting path, which is provided as a separate structure to communicate with a first venting path formed below the cell array structure, and in which high-temperature heat or the like generated from the trigger cell may be quickly and efficiently conducted to the pack case through a cooling tube and a port block and then dissipated before it accumulates, thereby suppressing the risk of ignition of the battery pack and delaying or blocking heat transfer therein.

The technical problems that the present disclosure seeks to solve are not limited to the above-mentioned problems, and other problems not mentioned above will be clearly understood by those skilled in the art from the description of the invention described below.

According to one aspect of the present disclosure, there is provided a battery pack that includes: a cell array structure including a plurality of battery cells; a pack case configured to accommodate the cell array structure and form a first venting path below the cell array structure; and a lower casing disposed at one end of the cell array structure inside the pack case and configured to form a second venting path communicating with the first venting path.

The second venting path may be formed perpendicular to the first venting path.

A plurality of venting holes may be formed in the lower casing at positions corresponding to the first venting path in the longitudinal direction.

The pack case may have at least one venting valve provided on both sides thereof.

Venting gas generated from the battery cell may be discharged to the outside through the venting valve by passing through the first venting path and the second venting path.

The pack case may include a bottom plate configured to come into partial contact with and support the bottom of the cell array structure and having a longitudinal cross-section in a concavo-convex shape, and the first venting path may be formed by the concavo-convex shape.

The cell array structure may include: a plurality of unit cell groups including the plurality of battery cells and a cooling tube attached to the plurality of battery cells; and a side frame disposed between the plurality of unit cell groups, and the first venting path may be formed parallel to the direction in which the plurality of battery cells, the cooling tube, and the side frame are disposed side by side.

The concavo-convex shape may be comprised of a convex section configured to come into contact with and support the cell array structure, and a concave section recessed from the convex section to form the first venting path. The convex section may be disposed in contact with the bottom of the side frame. The concave section may be disposed to be spaced apart from the bottom of the unit cell group, and the first venting path may be a space formed between the lower surface of the unit cell group and the concave section.

A battery pack according to the present disclosure may include: a cell array structure comprising a plurality of battery cells; a pack case configured to accommodate the cell array structure; and a port block connecting the cell array structure and the pack case to each other and configured to conduct heat generated from one of the battery cells to the pack case, thereby forming a heat dissipation path.

The battery pack may further include a lower casing disposed at one end of the cell array structure inside the pack case.

The port block may be provided to extend outward from one end of the cell array structure, and the lower casing may be disposed to be lower than the cell array structure such that the port block is supported on the upper surface of the lower casing.

The battery pack according to claim may include a heat transfer member interposed between the lower casing and the port block.

The cell array structure may further include the plurality of battery cells and a cooling tube attached to the plurality of battery cells, and the cooling tube may be provided to communicate with the port block.

The heat dissipation path may be formed from the battery cell to the cooling tube, the port block, and the pack case, or from the battery cell to the pack case via the cooling tube, the port block, and the lower casing.

In addition, according to the present disclosure, a vehicle including the battery pack described above may be provided.

According to one aspect of the present disclosure, the second venting path is provided as a separate structure to communicate with the first venting path formed below the cell array structure, thereby quickly discharging the venting gas generated from the trigger cell to the outside of the pack case.

According to another aspect of the present disclosure, the high-temperature heat generated in the trigger cell is able to be quickly and efficiently conducted to the pack case through the cooling tube and port block and then dissipated before it accumulates, thereby suppressing the risk of ignition of the battery pack and delaying or blocking heat transfer therein.

In accordance with an aspect of the present disclosure, a battery pack is provided. A battery pack according to this aspect may include a plurality of battery cells, a pack case defining a housing configured to accommodate the battery cells, a first venting path extending across the pack case, and a second venting path extending along at least one peripheral side of the pack case. The first venting path may provide a conduit for a gas generated from any of the battery cells. The second venting path may be in fluid communication with the first venting path and an opening on the pack case such that the gas from the battery cells is configured to travel from the first venting path to the second venting path and to be discharged from the battery pack via the opening.

Continuing in accordance with this aspect, the battery pack may include a cooling tube in contact with the battery cells. The cooling tube may contact the pack case such that heat generated by any of the battery cells is configured to be transferred via the cooling tube to the pack case by conduction and discharged from the pack case. The heat being discharged from the pack case may be discharged by convection. The heat transfer from the battery cell to the pack case may be conducted via a structure of the second venting path to the pack case. The battery pack may include a heat transfer member forming a bridge between the cooling tube and the pack case. The first venting path may be in fluid communication with the second venting path via a venting hole.

Continuing in accordance with this aspect, the opening may be a venting valve. The venting valve may be configured to forcibly discharge the gas from the pack case.

Continuing in accordance with this aspect, the battery cells may be accommodated in the housing in a linear array.

Continuing in accordance with this aspect, the second venting path may be perpendicular to the first venting path.

Continuing in accordance with this aspect, the first venting path may be defined by the pack case and a bottom plate.

In accordance with another aspect of the present disclosure, a battery pack is provided. A battery pack according to this aspect may include a plurality of battery cells, a pack case defining a housing configured to accommodate the battery cells, and a cooling tube in contact with the battery cells, the cooling tube contacting the pack case. Heat generated by any of the battery cells may be configured to be transferred via the cooling tube to the pack case by conduction and discharged from the pack case to an outside via convection.

Continuing in accordance with this aspect, the battery pack may include a first venting path extending across the pack case. The first venting path may provide a conduit for a gas generated from any of the battery cells. A second venting path may extend along at least one peripheral side of the pack case. The second venting path may be in fluid communication with the first venting path and an opening on the pack case such that the gas from the battery cells may be configured to travel from the first venting path to the second venting path and to be discharged from the battery pack via the opening.

Continuing in accordance with this aspect, the heat being discharged from the pack case may be discharged by convection.

Continuing in accordance with this aspect, the heat transfer from the battery cell to the pack case may be conducted via a structure of the second venting path to the pack case. The battery pack may further include a heat transfer member forming a bridge between the cooling tube and the pack case. The first venting path may be in fluid communication with the second venting path via a venting hole.

Continuing in accordance with this aspect, the opening may be a venting valve. The venting valve may be configured to forcibly discharge the gas from the pack case.

Continuing in accordance with this aspect, the battery cells may be accommodated in the housing in a linear array.

Continuing in accordance with this aspect, the second venting path may be perpendicular to the first venting path.

Continuing in accordance with this aspect, the first venting path may be defined by the pack case and a bottom plate.

The effects obtainable from the present disclosure are not limited to the above-mentioned effects, and other effects not mentioned above will be clearly understood by those skilled in the art from the description of the invention described below.

### BRIEF DESCRIPTION OF THE DRAWINGS

The accompanying drawings illustrate embodiments of the present disclosure and, together with the detailed description of the invention, serve to provide further understanding of the technical idea of the present disclosure, and thus, the present disclosure is not construed as being limited to the drawings.

FIG. 1 is a perspective view of a battery pack according to an embodiment of the present disclosure.

FIG. 2 is an exploded perspective view illustrating primary elements of the battery pack of FIG. 1.

FIG. 3 is a perspective view of a battery pack from which a top cover plate is removed according to an embodiment of the present disclosure.

FIG. 4 is a perspective view of a pack case and a lower casing in a battery pack according to an embodiment of the present disclosure.

FIG. 5 is a top view of the battery pack shown in FIG. 4.

FIG. 6 is a schematic view of a cell array structure applied to a battery pack according to an embodiment of the present disclosure.

FIG. 7 is a perspective view of a port block connected to a cooling tube of FIG. 6.

FIG. 8 is a top view of an upper portion of a cell array structure accommodated in a battery pack according to an embodiment of the present disclosure.

FIG. 9 is a longitudinal cutaway perspective view of a battery pack according to an embodiment of the present disclosure.

FIG. 10 is a partially enlarged side view of a longitudinal cross-section of a battery pack according to an embodiment of the present disclosure.

FIG. 11 is a schematic diagram illustrating the movement path of venting gas in a battery pack according to an embodiment of the present disclosure.

FIG. 12 is a schematic diagram illustrating a heat dissipation path through which heat is conducted and dissipated from a heating electrode in a battery pack according to an embodiment of the present disclosure.

FIG. 13 is a perspective view a vehicle according to an embodiment of the present disclosure.

### DETAILED DESCRIPTION

Hereinafter, preferred embodiments of the present disclosure will be described in detail with reference to the accompanying drawings. Prior to the description, it should be understood that the terms used in the specification and the appended claims should not be construed as limited to general and dictionary meanings, but interpreted based on the meanings and concepts corresponding to technical aspects of the present disclosure on the basis of the principle that the inventor is allowed to define terms appropriately for the best explanation.

Therefore, the configurations proposed in the embodiments and drawings of this specification indicate only embodiments of the present disclosure and do not represent all technical ideas of the present disclosure, so it should be understood that various equivalents and modifications could be made thereto at the time of filing the application.

The sizes of respective elements or specific parts of each element shown in the attached drawings are exaggerated, omitted, or simplified for convenience of explanation and clarification thereof. Accordingly, the sizes of respective elements do not entirely reflect their actual sizes. Descriptions of related known functions or configurations, which may obscure the subject matter of the present disclosure, will be omitted.

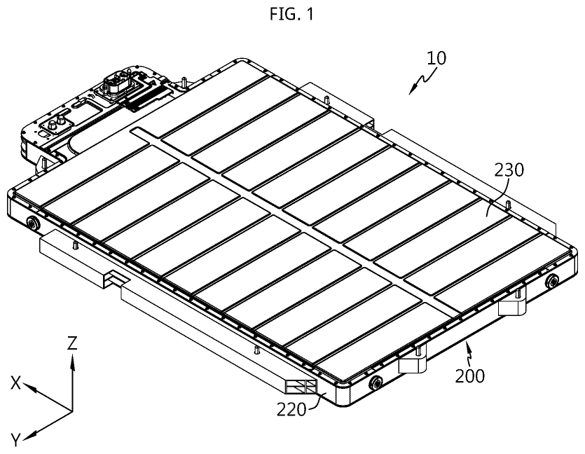

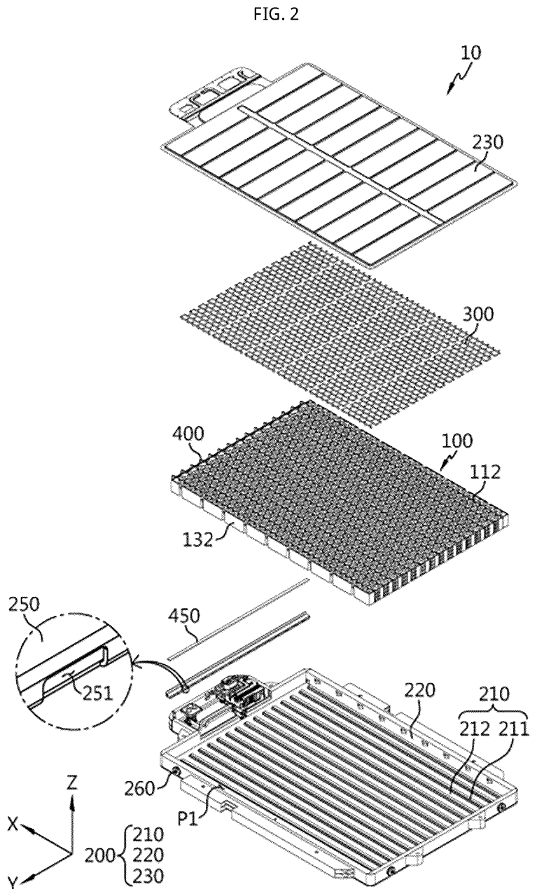

FIG. 1 is a perspective view of a battery pack according to an embodiment of the present disclosure, and FIG. 2 is an exploded perspective view illustrating the primary elements of the battery pack in FIG. 1.

Referring to FIGS. 1 and 2, a battery pack 10 according to an embodiment of the present disclosure may include a cell array structure 100 including a plurality of battery cells 112, a pack case 200 that accommodates the cell array structure 100, and a bus-bar assembly 300.

Referring to FIG. 2, the cell array structure 100 may include a plurality of battery cells 112.

The plurality of battery cells 112 may be secondary batteries and may be provided as cylindrical secondary batteries, pouch-type secondary batteries, or prismatic secondary batteries. Hereinafter, the present embodiment will be described on the assumption that the plurality of battery cells 112 is provided as cylindrical secondary batteries. These battery cells 112 may be a plurality of cylindrical secondary batteries arranged in the horizontal direction while standing in the upward/downward direction.

The plurality of battery cells 112 standing as described above may be stacked in the horizontal direction or on a horizontal plane (X-Y plane) as shown in FIG. 2. In addition, a cooling structure may be interposed between the plurality of battery cells 112, or a structure that maintains the distance between the battery cells 112 may be coupled to form a cell array structure 100, which is a single battery cell 112 assembly.

Although the cell array structure 100 will be described in detail later, it may be a single assembly (structure) configured in a flat plate having a predetermined thickness (e.g., the height of the battery cell 112). In addition, the cell array structure 100 may have a large area. Such a single structure having a large area may secure a certain level of structural rigidity.

A port block 400 connected to a cooling tube 115 may be provided on one side of the cell array structure 100 to protrude. The configuration and operational effects of the port block 400 will be described in detail later.

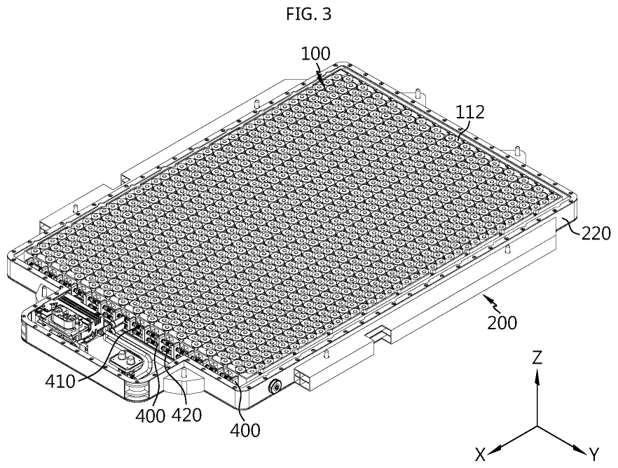

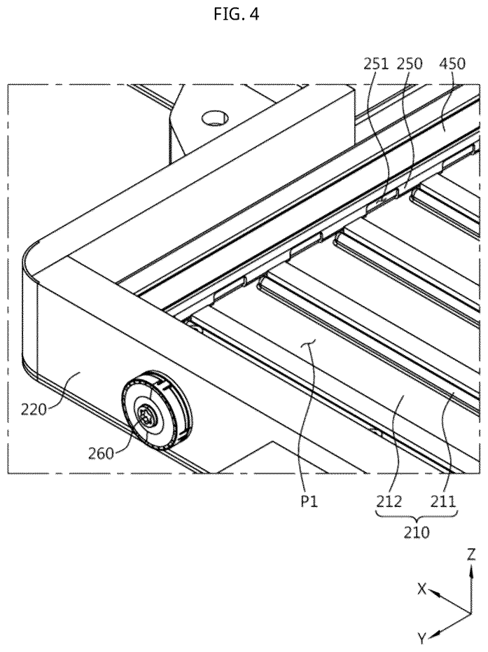

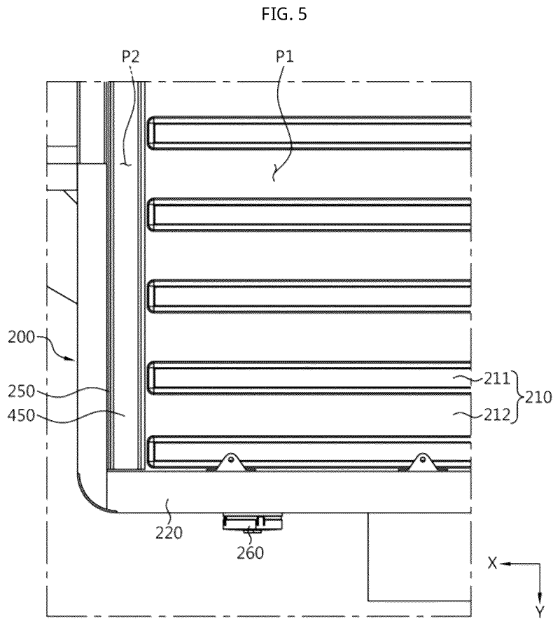

FIG. 3 is a perspective view of a battery pack from which a top cover plate is removed according to an embodiment of the present disclosure, FIG. 4 is a perspective view of a pack case and a lower casing 250 in a battery pack according to an embodiment of the present disclosure, and FIG. 5 is a top view of the battery pack shown in FIG. 4.

Referring to FIGS. 3 to 5 and the preceding FIGS. 1 and 2, the pack case 200 may accommodate the cell array structure 100. As shown in FIGS. 2 and 3, the pack case 200 may include a bottom plate 210, an outer side wall 220 disposed on the edge of the bottom plate 210, and a top cover plate 230. Here, the cell array structure 100 may be accommodated in the inner space formed by the bottom plate 210, the outer side wall 220, and the top cover plate 230.

The bottom plate 210 may be disposed at the bottom of the cell array structure 100. The bottom plate 210 may come into partial contact with the cell array structure 100 at the bottom thereof, thereby supporting the same.

To this end, the bottom plate 210 may be configured to have a longitudinal cross-section of a concavo-convex shape in one direction, as shown in FIG. 4. The convex structure and the concave structure may be formed parallel to the longitudinal direction (the X-axis direction) of the battery pack 10. In addition, the concavo-convex shape may be formed in a direction (the Y-axis direction) perpendicular to the direction (the X-axis direction) in which the plurality of battery cells 112, the cooling tube 115, and the side frames 130 are disposed side by side. In addition, the concavo-convex shape may form a first venting path P1.

Specifically, the concavo-convex shape may be comprised of a convex section 211 that comes into contact with and supports the cell array structure 100, and a concave section 212 that is provided to be recessed from the convex section 211. Here, the cell array structure 100 may come into contact with the convex section 211 so as to be seated and supported thereon. In addition, the concave section 212 may be formed to be recessed from the convex section 211. As described above, the first venting path P1 may be formed in the space between the convex sections 211, that is, in the concave section 212. That is, the first venting path P1 may be a space formed between the lower surface of the unit cell group and the concave section 212. Accordingly, the first venting path P1 may be provided on the bottom plate 210 of the pack case 200 in the direction (the X-axis direction) in which the plurality of battery cells 112, the cooling tube 115, and the side frame 130 are arranged in a row.

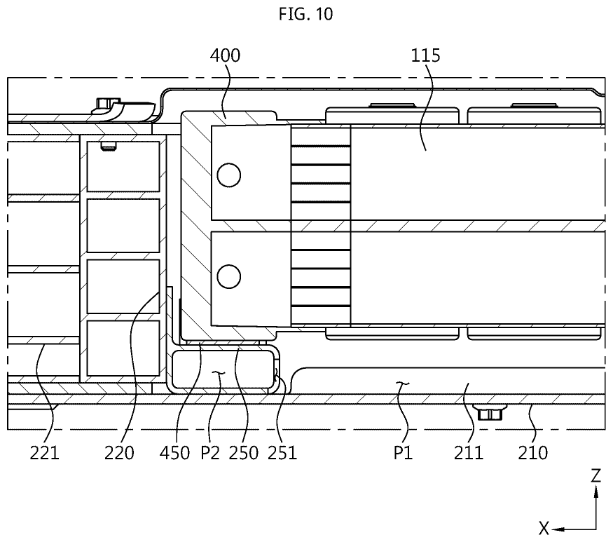

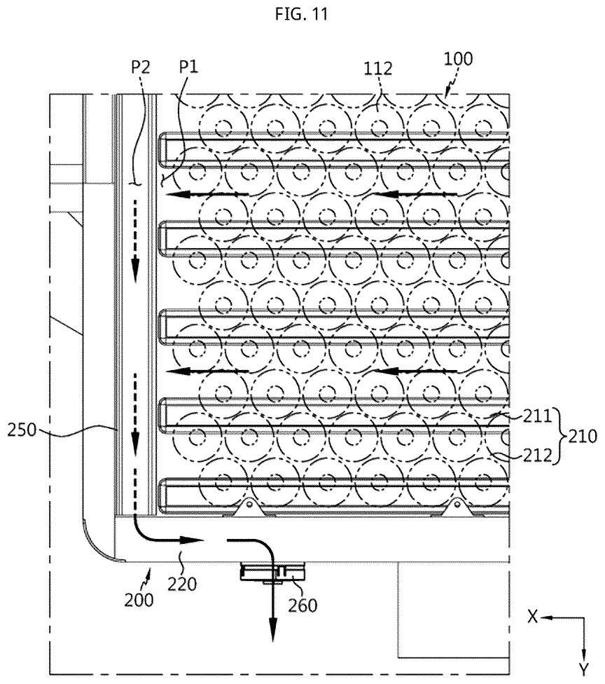

The outer side wall 220 indicates a type of frame that has a predetermined height and is disposed on the outer edge, and the bottom plate 210 may be coupled to the lower part of the outer side wall 220. The outer side wall 220 may have a hollow therein and may be provided with a plurality of reinforcement partitions 221 (see FIGS. 10 and 11). The outer side wall 220 may have at least one venting valve 260 provided on both sides thereof to be connected to a second venting path P2, which will be described later.

Meanwhile, in the battery pack 10 according to the present embodiment, the pack case 200 may further include a lower casing 250 and a venting valve 260 forming a second venting path P2.

Referring to FIGS. 2, 4, and 5, the lower casing 250 may be disposed at one end of the cell array structure 100 inside the pack case 200. In addition, the lower casing 250 may be disposed lower than the cell array structure 100.

This lower casing 250 may form a second venting path P2. The second venting path P2 may be formed perpendicular to the first venting path P1. That is, the second venting path P2 may be formed in the direction (the Y-axis direction) perpendicular to the direction (the X-axis direction) in which the plurality of battery cells 112, the cooling tube 115, and the side frame 130 are arranged in a row. In addition, the length of the lower casing 250 may be substantially the same as the length of the cell array structure 100 in the width direction. Accordingly, both ends of the lower casing 250 may be disposed to almost reach the inner walls of the outer side wall 220 disposed on both sides of the pack case 200 in the width direction.

The lower casing 250 may have a plurality of venting holes 251 formed in the longitudinal direction at positions corresponding to the first venting path P1. The first venting path P1 and the second venting path P2 of the lower casing 250 may communicate with each other through the venting hole 251. Accordingly, venting gas and the like generated from one trigger cell may be vented in the X-axis direction through the first venting path P1 below the cell array structure 100, introduced into the lower casing 250 through the venting hole 251, and then rapidly discharged toward the outer side wall 220 (in the Y-axis direction) through the second venting path P2.

In addition, the venting valve 260 may be provided in the pack case 200. At least one venting valve 260 may be provided on the outer side wall 220. The venting valve 260 may be configured to forcibly discharge the venting gas from the pack case 200 to the outside. For example, a pair of venting valves 260 may be provided on the outer side wall 220 of the pack case 200 where both ends of the lower casing 250 come into contact. The venting gas or the like discharged through the above-described first venting path P1 and second venting path P2 is quickly discharged to the outside through the venting valve 260 adjacent thereto.

According to the present embodiment, venting gas generated from the trigger cell may be quickly discharged through the first venting path P1 formed below the cell array structure 100 and the second venting path P2. That is, it may be quickly vented to the edge of the pack case 200 and then quickly discharged to the outside through the venting valve 260. In this process, adverse effects on the adjacent battery cells 112 or other components may be minimized.

Hereinafter, the cell array structure 100 and the port block 400 according to an embodiment of the present disclosure will be described in detail.

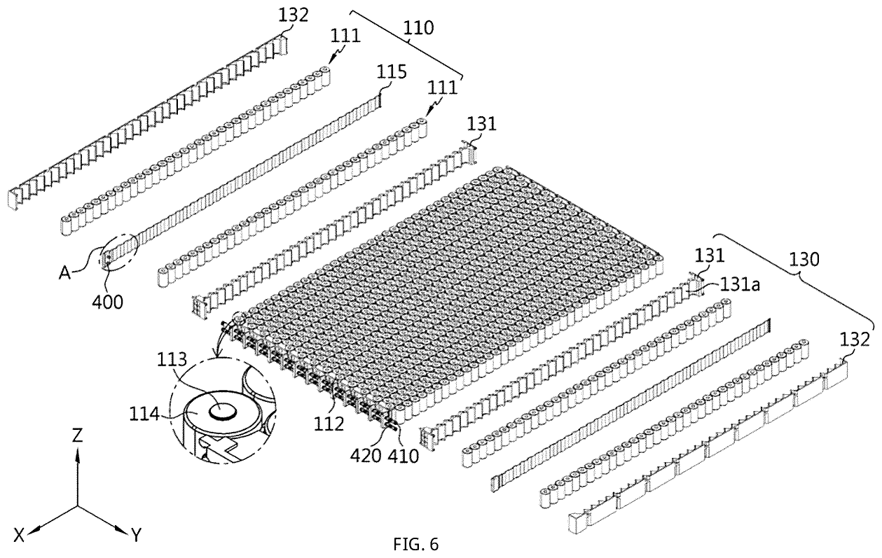

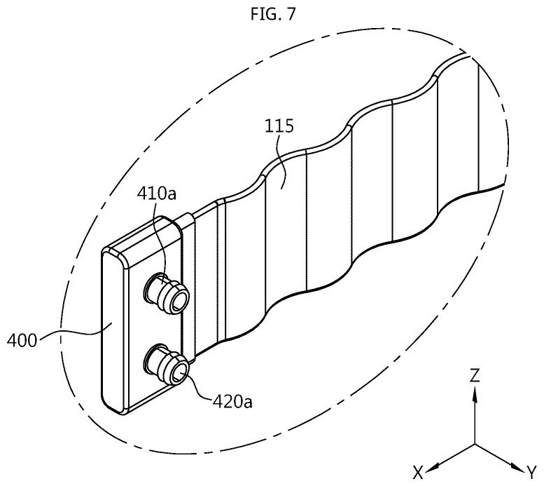

FIG. 6 is a diagram illustrating a cell array structure applied to a battery pack according to an embodiment of the present disclosure, and FIG. 7 is a perspective view of a port block connected to the cooling tube in FIG. 6.

Referring to FIGS. 6 and 7 and the preceding FIG. 2, the cell array structure 100 may include a unit cell group 110 that includes a plurality of battery cells 112 and a cooling tube 115 attached to the plurality of battery cells 112, and a side frame 130 disposed between the plurality of unit cell groups 110.

The battery cell 112 may have a tab portion 113 and an upper surface 114 at the top. The tab portion 113 may have a first polarity, and the upper surface 114 may have a second polarity. The tab portion 113 and the upper surface 114 may be electrically insulated from each other. The first polarity may correspond to a positive electrode of the battery cell 112, and the second polarity may correspond to a negative electrode of the battery cell 112. That is, the tab portion 113 may be a positive electrode of the battery cell 112, and the upper surface 114 may be a negative electrode of the battery cell 112. The tab portion 113 may be provided to protrude from the upper surface 114. Alternatively, the tab portion 113 may be configured not to protrude from the upper surface 114. For example, it may be configured in a so-called tab-less structure in which the tab portion 113 is disposed on the same plane as the upper surface. Since the configurations of the battery cell 112 are widely known to those skilled in the art at the time of filing the present disclosure, detailed descriptions thereof will be omitted from this specification.

A plurality of such battery cells 112 may constitute one cell array 111. That is, the cell arrays 111 may have a plurality of battery cells arranged in a row in the longitudinal direction (the X-axis direction) of the battery pack 10. The number of battery cells 112 constituting the cell array 111 is not limited.

In addition, the unit cell group 110 may include a pair of cell arrays 111 and a cooling tube 115 between them. That is, the unit cell group 110 may include a pair of (two) cell arrays 111 and a cooling tube 115 interposed between the pair of cell arrays 111. Here, the cooling tube 115 is an element that is in contact with one side of the cell array 111 to cool the battery cells 112. The cooling tube 115 may have an empty space through which a cooling medium flows, and may come into contact with the outer surfaces of the plurality of battery cells 112, so that heat generated from the battery cells 112 may directly transfer to the cooling medium.

A port block 400 may be connected to one end of the cooling tube 115. The port block 400 may be provided with ports 410a and 420b coupled to connection pipes 410 and 420. In addition, the port block 400 is an element constituting a heat dissipation path, which will be described in detail later.

The unit cell group 110 has inevitably a curved section because the plurality of battery cells 112 is disposed on the outer surface thereof. Accordingly, the cell array structure 100 may have a side frame 130 that accommodates the curved section and maintains and fixes the distance between the plurality of battery cells 112.

The side frame 130 may be provided between the unit cell group 110 and a neighboring unit cell group 110, or at the front end of the unit cell group 110. Specifically, the side frame 130 may include a side structure 131 interposed between the unit cell groups 110, and a side wall 132 interposed between the pack case 200 and the unit cell group 110.

The side structure 131 may be disposed between the pair of unit cell groups 110. The side structure 131 may be disposed between the unit cell group 110 and the neighboring unit cell group 110 to fix at least one pair of unit cell groups 110 and maintain the distance between the battery cells 112. As shown in FIGS. 2 and 3, the side structure 131 may have concave portions 131a formed corresponding to the outer shape of the unit cell group 110 on one surface and the other surface, respectively, in the longitudinal direction. The inner curvature or number of the concave portions 131a may be determined according to the specifications of the outer surface of the unit cell group 110 or battery cell 112 that is coupled to the side structure 131 by shape-matching.

A pair of side walls 132 may be disposed on both sides in the assembly direction (the Y-axis direction) in which the unit cell group 110 and the side structure 131 are assembled. The side wall 132 may be provided at the outermost portion of the cell array structure 100 in the width direction (the X-axis direction). One side of the side wall 132 may have the above-described concave portion 133 to receive one side of the unit cell group 110, and the other side (opposite side) may be configured to be flat so as to be in contact with the outer surface of the pack case 200. Accordingly, the cell array structure 100 and the outer side wall 220 may be in contact with each other, removing gaps therebetween.

As described above, a plurality of unit cell groups 110 and a plurality of side structures 131 and side walls 132 may be assembled to configure one cell array structure 100. The cell array structure 100 with the above configuration may be a structure capable of ensuring structural rigidity without a separate module case.

Specifically, the side frame 130 may be disposed between the plurality of battery cells 112 in the cell array structure 100 or disposed on one side of the cell array 111, thereby fixing and supporting the plurality of battery cells 112. In addition, the side frame 130 may be attached to the plurality of battery cells 112 to form a single structure as a cell array structure 100 having a larger area than existing ones.

Hereinafter, the heat dissipation configuration according to the present embodiment will be described.

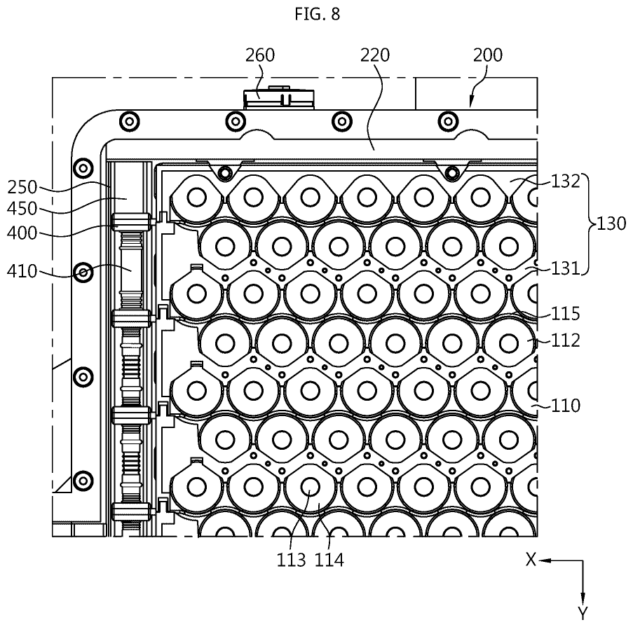

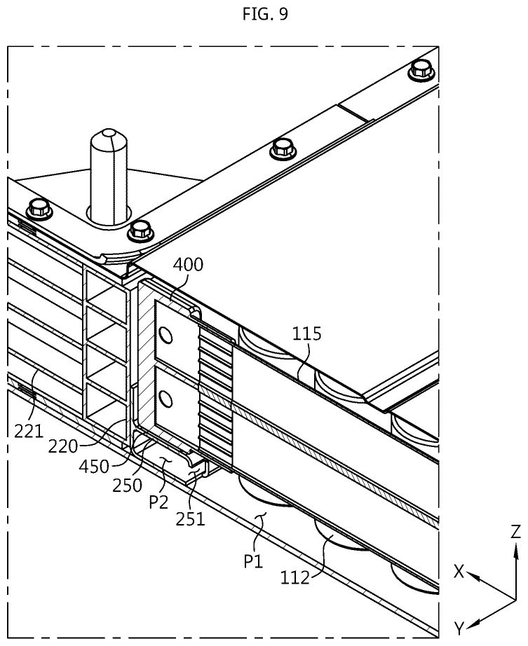

FIG. 8 is a diagram illustrating an upper portion of a cell array structure accommodated in a battery pack according to an embodiment of the present disclosure, FIG. 9 is a longitudinal cutaway perspective view of the battery pack according to an embodiment of the present disclosure, and FIG. 10 is an enlarged view of a longitudinal cross-section of a battery pack according to an embodiment of the present disclosure.

Referring to FIG. 8 and previous FIGS. 2, 6, and 7, the battery pack 10 according to the present embodiment may include a port block 400 connected to the cell array structure 100.

The port block 400 may be connected to one end of the cooling tube 115. The port block 400 may be provided such that the port block 400 and the cooling tube 115 communicate with each other. The port block 400 may be provided to protrude from the side of the cell array structure 100. That is, the port block 400 may be configured to protrude further than the end of the side frame 130 in the assembled state of the cell array structure 100. The port block 400 may have a space in which the cooling medium is temporarily stored, and may be connected to the adjacent port block 400 through a pair of connection pipes 410 and 420. The upper connection pipe 410 of the port block 400 may serve as an inlet passage for the cooling medium, and the lower connection pipe 420 may serve as an outlet passage for the cooling medium. Accordingly, the introduced cooling medium may move along the connection pipes 410 and 420 to be temporarily stored in the port block 400, and may enter and exit the cooling tube 115.

The port block 400 may partially connect the cell array structure 100 and the pack case 200 and conduct heat generated from any one of the battery cells 112 to the pack case 200, thereby configuring a heat dissipation path.

Specifically, the port block 400 may be provided to extend outward from one end of the cell array structure 100 and may partially connect the cell array structure 100 and the pack case 200. That is, as shown in FIG. 8, both ends of the port block 400 may come into contact with both the side of the cell array structure 100 and the outer side wall 220.

Referring to FIGS. 9 and 10, the lower casing 250 may be disposed at one end of the cell array structure 100 to be lower than the cell array structure 100. Accordingly, the port block 400 may be supported on the upper surface of the lower casing 250. In addition, one side of the lower casing 250 may be disposed in contact with the outer side wall 220.

A heat transfer member 450 may be included to be interposed between the lower casing 250 and the port block 400.

Accordingly, the port block 400 may be connected to the cooling tube 115 of the cell array structure 100, and the opposite side thereof may come into partial contact with the outer side wall 220, so that the bottom of the port block 400 may be supported on the lower casing 250 with the heat transfer member 450 interposed therebetween. That is, if high-temperature heat is generated in a heating electrode (ignition source) such as a trigger cell due to a thermal event, the generated high-temperature heat may be conducted to the cooling tube 115, transferred to the port block 400, and then conducted to the pack case 200 through the lower casing 250 in contact with the port block 400, so that various other components, especially the pack case 200, may function as thermal masses.

According to the present embodiment, the high-temperature heat or the like generated in the trigger cell may be quickly and efficiently conducted to the pack case 200 through the cooling tube 115 and port block 400 and then dissipated before it accumulates, thereby suppressing the risk of ignition of the battery pack 10 and delaying or blocking heat transfer therein.

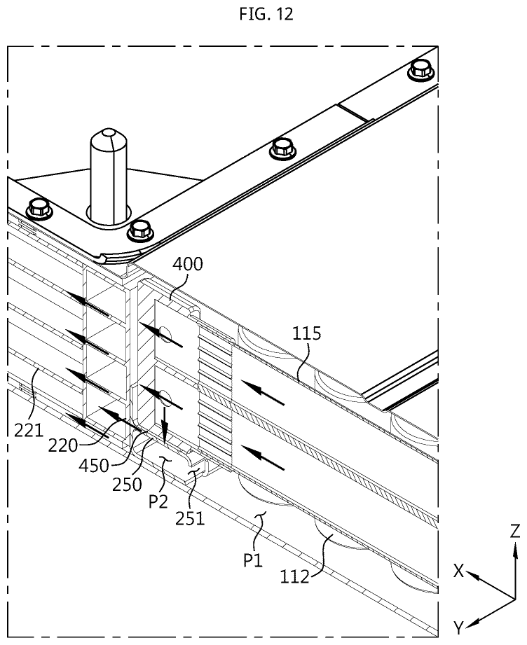

FIG. 11 is a diagram illustrating the movement path of venting gas in a battery pack according to an embodiment of the present disclosure, and FIG. 12 is a diagram illustrating a heat dissipation path through which heat is conducted and dissipated from a heating electrode in a battery pack according to an embodiment of the present disclosure.

The details the structural and functional components of a battery pack are key to its cooling and heat dissipation mechanisms. The port block connected to the cell array structure and one end of the cooling tube, enables communication and protrusion from the cell array. The port block temporarily stores the cooling medium and connects to adjacent port blocks through connection pipes serving as inlet and outlet passages. The port block extends outward, partially connecting the cell array to the pack case, thus facilitating heat transfer from the battery cells to the pack case. This configuration, supported by a lower casing and a heat transfer member, ensures efficient conduction of high-temperature heat generated by a trigger cell to the pack case, enhancing safety by quickly dissipating heat and reducing the risk of ignition.

Hereinafter, the flow of venting gas generated from a trigger cell of the cell array structure 100 in the battery pack 10 according to the present embodiment will be described with reference to FIGS. 1 to 11.

First, the process of assembling the cell array structure 100 to the pack case 200 will be briefly described.

Referring to FIG. 6, a plurality of battery cells 112 is provided as one cell array 111, and a cooling tube 115 is interposed between a pair of cell arrays 111 to be assembled to one unit cell group 110. A side structure 131 is interposed between the unit cell groups 110, and a side wall 132 is attached to the outermost portion of the battery pack 10 in the width direction (the Y-axis direction) to form one cell array structure 100. The cell array structure 100 may be further coated with adhesive resin or structural resin. In addition, assembling of the cell array structure 100 may require separate assembly equipment or pressurizing equipment.

Referring to FIGS. 3 and 11, the lower casing 250 may be coupled to the pack case 200. The lower casing 250 may communicate with the first venting path P1 and may form the second venting path P2 perpendicular to the first venting path P1.

As shown in FIG. 10, the cell array structure 100 may be seated on the pack case 200. The convex section 211 may come into contact with and support the bottom of the side structure 131 or the bottom of the side wall 132. When the cell array structure 100 is seated, the concave section 212 may be disposed to be spaced apart from the bottom of the unit cell group 110. As shown in FIGS. 3 and 4, the first venting path P1 may be formed as a space between the bottom of the unit cell group 110 and the concave section 212.

Referring to FIG. 11, the second venting path P2 may be provided as a separate structure to communicate with the first venting path P1 formed below the cell array structure 100, thereby quickly discharging the venting gas generated from the trigger cell to the outside of the pack case 200. This configuration allows for the rapid discharge of venting gas generated from the trigger cell to the exterior of the pack case 200. The strategic placement of the venting paths ensures that the high-temperature venting gas is efficiently expelled, minimizing the risk of thermal damage to surrounding battery cells and other components.

According to the present embodiment, venting gas generated from the trigger cell may be quickly discharged through the first venting path P1 formed below the cell array structure 100 and the second venting path P2. That is, the gas may be quickly vented to the edge of the pack case 200 and then quickly discharged to the outside through the venting valve 260. In this process, since high-temperature venting gas or the like is quickly discharged without contacting the adjacent battery cells 112 or other components, adverse effects such as heat accumulation in adjacent components may be minimized.

Next, the heat dissipation process will be explained.

Referring to FIG. 12, the heat dissipation path may be formed from the battery cell 112 to the cooling tube 115, the port block 400, and the pack case 200, or from the battery cell 112 to the pack case 200 via the cooling tube 115, the port block 400, and the lower casing 250. This dual-path system enhances the efficiency and effectiveness of heat management within the battery pack.

Specifically, high-temperature heat generated in a heating electrode (ignition source) such as a trigger cell due to a thermal event may be conducted to the cooling tube 115, transferred to the port block 400, and then reach the pack case 200 through the lower casing 250 in contact with the port block 400. Alternatively, heat may be conducted directly from the port block 400 to the pack case 200, thereby forming the heat dissipation path. Accordingly, as described above, various other components, especially the pack case 200, may function as thermal masses.

As described above, the high-temperature heat generated in the trigger cell is able to be quickly and efficiently conducted to the pack case 200 through the cooling tube 115 and port block 400 and then dissipated before it accumulates, thereby suppressing the risk of ignition of the battery pack 10 and delaying or blocking heat transfer therein.

Meanwhile, referring back to FIG. 2, the battery pack 10 according to the present embodiment may include a bus-bar assembly 300. The bus-bar assembly 300 may be disposed on the cell array structure 100 to electrically connect the plurality of battery cells 112.

In addition, the battery pack 10 according to the present disclosure, although not shown, may further include various devices for controlling charging and discharging of the battery pack 10, such as a BMS (Battery Management System), a current sensor, a fuse, or the like.

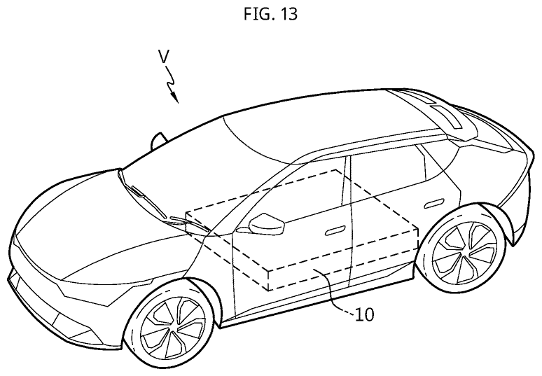

FIG. 13 is a diagram illustrating a vehicle according to an embodiment of the present disclosure.

Referring to FIG. 13, the battery pack 10 according to the present disclosure may be applied to a vehicle V such as an electric vehicle or a hybrid vehicle. That is, the vehicle V according to the present disclosure may include the battery pack 10 according to the present disclosure. The battery pack 10 may be installed in the car body frame under the vehicle seat or the trunk space, and the arrangement sequence of the battery pack 10 may be reversed if necessary, when installed in the vehicle.

In another embodiment of the present disclosure, battery pack 10 can include a plurality of battery cells 112 arranged in a cell array structure 100. Cell array structure 100 can include a plurality of unit cell groups 110, each consisting of multiple battery cells 112 and a cooling tube 115 attached to the battery cells 112 for effective heat dissipation.

The cell array structure 100 is accommodated within a pack case 200, which defines a housing for the battery cells 112. The pack case 200 can include a bottom plate 210, outer side walls 220, and a top cover plate 230. The bottom plate 210 is configured with a longitudinal cross-section of a concavo-convex shape to support the cell array structure 100. This concavo-convex shape forms a first venting path P1 that extends across the pack case 200.

The first venting path P1 serves as a conduit for venting gas generated from any of the battery cells 112 in the event of a thermal event or failure. The concave sections 212 of the bottom plate 210 provide the necessary space for the first venting path P1 to be effective in channeling the gas away from the battery cells 112.

Additionally, the pack case 200 includes a lower casing 250 disposed at one end of the cell array structure 100. The lower casing 250 is configured to form a second venting path P2 that extends along at least one peripheral side of the pack case 200. The second venting path P2 is perpendicular to the first venting path P1 and is in fluid communication with it via a plurality of venting holes 251 formed in the lower casing 250.

The pack case 200 is further reinforced by a plurality of reinforcement partitions 221 within the outer side walls 220 to maintain structural integrity and prevent deformation under stress or thermal conditions. The venting valves 260 are provided on the outer side walls 220 of the pack case 200 at the points where the second venting path P2 terminates. These venting valves 260 enable the rapid discharge of venting gas from the battery pack 10 to the external environment, thereby preventing heat accumulation and potential ignition within the pack.

In operation, venting gas generated from any of the battery cells 112 travels through the first venting path P1, enters the second venting path P2 via the venting holes 251, and is then discharged from the battery pack 10 through the venting valves 260. This dual-path venting structure ensures efficient and safe management of venting gases, thereby enhancing the safety and reliability of the battery pack 10.

To further enhance the thermal management of the battery pack 10, the cell array structure 100 includes a port block 400 connected to the cooling tube 115. The port block 400 is configured to extend outward from one end of the cell array structure 100 and come into contact with the outer side walls 220 of the pack case 200. A heat transfer member 450 is interposed between the lower casing 250 and the port block 400 to facilitate efficient heat transfer.

The cooling tube 115, which is interposed between pairs of cell arrays 111 within the unit cell groups 110, circulates a cooling medium to absorb and dissipate heat generated by the battery cells 112. The port block 400, in communication with the cooling tube 115, serves as a heat dissipation path, conducting heat away from the battery cells 112 and transferring it to the pack case 200. This configuration ensures that high-temperature heat is quickly and efficiently conducted away from the battery cells 112, thereby suppressing the risk of ignition and delaying or blocking heat transfer within the battery pack 10.

The battery pack 10 is also designed to be integrated into a vehicle V, such as an electric vehicle or a hybrid vehicle. The battery pack 10 can be installed in the car body frame, under the vehicle seat, or in the trunk space. The arrangement of the battery pack 10 within the vehicle V can be adjusted as necessary to accommodate the vehicle's design and space constraints.

In an embodiment of the present disclosure, battery pack 10 can include a plurality of battery cells 112 arranged in a cell array structure 100. The cell array structure 100 includes multiple unit cell groups 110, each consisting of several battery cells 112. The battery cells 112 are typically cylindrical and are arranged in a standing orientation within the cell array structure 100. The cell array structure 100 is housed within a pack case 200, which includes a bottom plate 210, outer side walls 220, and a top cover plate 230. This pack case 200 protects and supports the battery cells 112 while facilitating heat dissipation.

A cooling tube 115 is interposed between the battery cells 112 within the unit cell groups 110. The cooling tube 115 is in direct contact with the battery cells 112, allowing for efficient thermal conduction. The cooling tube 115 circulates a cooling medium to absorb heat generated by the battery cells 112 during operation.

The cooling tube 115 is also in contact with the pack case 200, specifically the outer side walls 220 and the bottom plate 210. This ensures that heat from the battery cells 112 is transferred via the cooling tube 115 to the pack case 200 by conduction.

The pack case 200, acting as a thermal mass, facilitates the dissipation of this heat to the external environment through convection. The outer side walls 220 and bottom plate 210 of the pack case 200 maximize surface area exposure, enhancing the convection process.

In operation, the cooling medium within the cooling tube 115 absorbs heat from the battery cells 112. The heat is then conducted through the cooling tube 115 to the pack case 200, which dissipates the heat to the outside environment through convection. This efficient heat management system ensures that the battery cells 112 operate within a safe temperature range, enhancing the overall performance and safety of the battery pack 10.

The battery pack 10 is designed to be integrated into a vehicle V, such as an electric or hybrid vehicle, and can be installed in various locations within the vehicle, including the car body frame, under the seat, or in the trunk space.

Meanwhile, although terms indicating directions such as upward, downward, left, right, forward, and backward directions are used in this specification, it is obvious to those skilled in the art that these terms are only for convenience of explanation and may vary depending on the location of the target object or the location of the observer.

As described above, although the present disclosure has been described with reference to limited embodiments and drawings, the present disclosure is not limited thereto, and various modifications and variations are possible within the technical idea of the present disclosure and the scope of equivalence of the claims to be described below by those skilled in the art to which the present disclosure pertains.

1. A battery pack comprising:
a plurality of battery cells;
a pack case defining a housing configured to accommodate the battery cells;
a first venting path extending across the pack case, the first venting path providing a conduit for a gas generated from any of the battery cells, and
a second venting path extending along at least one peripheral side of the pack case,
wherein the second venting path is in fluid communication with the first venting path and an opening on the pack case such that the gas from the battery cells is configured to travel from the first venting path to the second venting path and to be discharged from the battery pack via the opening.

2. The battery pack of claim 1, further including a cooling tube in contact with the battery cells, the cooling tube contacting the pack case such that heat generated by any of the battery cells is configured to be transferred via the cooling tube to the pack case by conduction and discharged from the pack case.

3. The battery pack of claim 2, wherein the heat being discharged from the pack case is discharged by convection.

4. The battery pack of claim 3, wherein the heat transfer from the battery cell to the pack case is conducted via a structure of the second venting path to the pack case.

5. The battery pack of claim 4, further including a heat transfer member forming a bridge between the cooling tube and the pack case.

6. The battery pack of claim 4, wherein the first venting path is in fluid communication with the second venting path via a venting hole.

7. The battery pack of claim 1, wherein the opening is a venting valve.

8. The battery pack of claim 7, wherein the venting valve is configured to forcibly discharge the gas from the pack case.

9. The battery pack of claim 1, wherein the battery cells are accommodated in the housing in a linear array.

10. The battery pack of claim 1, wherein the second venting path is perpendicular to the first venting path.

11. The battery pack of claim 1, wherein the first venting path is defined by the pack case and a bottom plate.

12. A battery pack comprising:
a plurality of battery cells;
a pack case defining a housing configured to accommodate the battery cells, and
a cooling tube in contact with the battery cells, the cooling tube contacting the pack case,
wherein heat generated by any of the battery cells is configured to be transferred via the cooling tube to the pack case by conduction and discharged from the pack case to an outside via convection.

13. The battery pack of claim 12, further including a first venting path extending across the pack case, the first venting path providing a conduit for a gas generated from any of the battery cells, a second venting path extending along at least one peripheral side of the pack case, wherein the second venting path is in fluid communication with the first venting path and an opening on the pack case such that the gas from the battery cells is configured to travel from the first venting path to the second venting path and to be discharged from the battery pack via the opening.

14. The battery pack of claim 13, wherein the heat being discharged from the pack case is discharged by convection.

15. The battery pack of claim 14, wherein the heat transfer from the battery cell to the pack case is conducted via a structure of the second venting path to the pack case.

16. The battery pack of claim 15, further including a heat transfer member forming a bridge between the cooling tube and the pack case.

17. The battery pack of claim 16, wherein the first venting path is in fluid communication with the second venting path via a venting hole.

18. The battery pack of claim 13, wherein the opening is a venting valve.

19. The battery pack of claim 18, wherein the venting valve is configured to forcibly discharge the gas from the pack case.

20. The battery pack of claim 13, wherein the battery cells are accommodated in the housing in a linear array.

21-22. (canceled)
